(19) United States
(12) Patent Application Publication
(10) Pub. No.: US 2020/0218871 A1
(43) Pub. Date: Jul. 9, 2020

(54) FINGERPRINT IDENTIFICATION APPARATUS AND METHOD THEREOF

(71) Applicant: Novatek Microelectronics Corp., Hsinchu (TW)

(72) Inventors: Cho-Hsuan Jhang, Hsinchu City (TW); Chih-Peng Hsia, Hsinchu County (TW); Wen-Shen Wuen, Hsinchu County (TW)

(73) Assignee: Novatek Microelectronics Corp., Hsinchu (TW)

(21) Appl. No.: 16/367,270

(22) Filed: Mar. 28, 2019

Related U.S. Application Data
(60) Provisional application No. 62/789,968, filed on Jan. 8, 2019.

(51) Int. Cl. G06K 9/00

(52) U.S. Cl. CPC G06K 9/0008; G06F 3/04166; G06K 9/0004

(57) ABSTRACT

A fingerprint identification apparatus including a touch and display integration circuit and a fingerprint identification device is provided. The touch and display integration circuit is configured to perform a touch and display function in each of a plurality of touch and display periods during a total contact time. An object touches a predetermined area of the display panel during the total contact time. The fingerprint identification device is configured to obtain a plurality of sample images of the object in each of a plurality of sensing periods during the total contact time. Two adjacent sensing periods have at least one of the touch and display periods therebetween. A fingerprint identification method of the fingerprint identification apparatus is also provided.

### CROSS-REFERENCE TO RELATED APPLICATION

This application claims the priority benefit of U.S. provisional application Ser. No. 62/789,968, filed on Jan. 8, 2019. The entirety of the above-mentioned patent applications is hereby incorporated by reference herein and made a part of this specification.

### BACKGROUND

### Technical Field

The disclosure relates to a fingerprint identification apparatus and a fingerprint identification method, specifically, to a fingerprint identification apparatus and a fingerprint identification method capable of providing a plurality of effective images of a fingerprint in a limited time.

### Description of Related Art

In conventional fingerprint recognition, a finger is in contact with a predetermined area on the panel in a limited time so that the fingerprint is obtained by an image sensor disposed in or under the panel. In the limited time, in addition to performing the fingerprint recognition function, the touch and display functions need performing also. Therefore, the actual time for performing the fingerprint recognition function is short.

Further, in performing the fingerprint recognition function, the image sensor is exposed to light in an exposure time, which cannot be shorten. The appropriate exposure time is determined by auto exposure (AE) process to avoid overexposing and underexposing, so that one image obtained by the image sensor is not too bright or too dark. However, the AE process is time-consuming, so not so many images are obtained in a short time. In addition, the AE process is suitable for judgment based on visualization and cannot guarantee an optimized image for fingerprint recognition.

### SUMMARY

The disclosure is directed to a fingerprint identification apparatus and a fingerprint identification method capable of providing a plurality of effective images of a fingerprint in a limited time.

The disclosure provides a fingerprint identification apparatus including a fingerprint identification device and a touch and display integration circuit. The touch and display integration circuit is configured to perform a touch and display function in each of a plurality of touch and display periods during a total contact time. An object touches a predetermined area of a display panel during the total contact time. The fingerprint identification device is configured to obtain a plurality of sample images of the object in each of a plurality of sensing periods during the total contact time. Two adjacent sensing periods have at least one of the touch and display periods therebetween.

In one embodiment of the disclosure, the plurality of sensing periods comprise a first sensing period and a last sensing period, and the fingerprint identification device is reset at a beginning of the first sensing period and at an end of the last sensing period.

In one embodiment of the disclosure, the fingerprint identification device is not reset between the beginning of the first sensing period and the end of the last sensing period.

In one embodiment of the disclosure, the plurality of sensing periods further comprise at least one intervening sensing period arranged between the first sensing period and the last sensing period.

In one embodiment of the disclosure, the plurality of sensing periods and the plurality of touch and display periods are alternately arranged during the total contact time.

In one embodiment of the disclosure, the fingerprint identification device is disposed in the display panel and above the touch and display integration circuit.

In one embodiment of the disclosure, the fingerprint identification device is integrated with the touch and display integration circuit in the display panel.

In one embodiment of the disclosure, the fingerprint identification device comprises an optical image sensor having a photodiode, and the photodiode is reset to reset the fingerprint identification device.

The disclosure provides a fingerprint identification method of a fingerprint identification apparatus having a fingerprint identification device and a touch and display integration circuit. An object is in contact with a predetermined area of a display panel during a total contact time. The fingerprint identification method includes the steps of performing, by the touch and display integration circuit, a touch and display function in each of a plurality of touch and display periods during the total contact time; obtaining, by the fingerprint identification device, a plurality of sample images of the object in each of a plurality of sensing periods during the total contact time; and obtaining a result image according to the plurality of sample images of the object in each of the plurality of sensing periods during the total contact time, wherein two adjacent sensing periods have at least one of the touch and display periods therebetween.

In one embodiment of the disclosure, the plurality of sensing periods comprise a first sensing period and a last sensing period, the fingerprint identification method further includes steps of resetting the fingerprint identification device at a beginning of the first sensing period; and resetting the fingerprint identification device at an end of the last sensing period.

In one embodiment of the disclosure, the fingerprint identification device is not reset between the beginning of the first sensing period and the end of the last sensing period.

In one embodiment of the disclosure, step of obtaining, by the fingerprint identification device, the plurality of sample images of the object in each of the plurality of sensing periods during the total contact time includes sub-steps of obtaining a first sample image; calculating an effect of environment light based on the first sample image; and obtaining other sample images of the plurality of sample images according to the effect of environment light.

In one embodiment of the disclosure, the object is a finger, step of obtaining the result image according to the plurality of sample images of the object in each of the plurality of sensing periods during the total contact time includes a sub-step of determining the result image according to a contrast between ridges and valleys of a fingerprint of the finger in the plurality of sample images in each of the plurality of sensing periods.

In one embodiment of the disclosure, step of obtaining the result image according to the plurality of sample images of the object in each of the plurality of sensing periods during the total contact time includes a sub-step of determining the result image by averaging the plurality of sample images in each of the plurality of sensing periods.

In one embodiment of the disclosure, the plurality of sensing periods comprise at least one intervening sensing period between the first sensing period and the last sensing period.

In one embodiment of the disclosure, the plurality of sensing periods and the plurality of touch and display periods are alternately arranged during the total contact time.

In one embodiment of the disclosure, the fingerprint identification device includes an optical image sensor having a photodiode, and the photodiode is reset to reset the fingerprint identification device.

Based on above, in the disclosure, two adjacent sensing periods have at least one of the touch and display periods therebetween, a plurality of sample images of the finger are obtained in each of the sensing periods. In addition, the first sample image in each of the sensing periods is used to calculate in order to obtain the effect of environment light, and the other sample images in the same sensing period are obtain by eliminating the effect of environment light. Further, the sensing periods have the first sensing period and the last sensing period. The fingerprint identification device is reset at the beginning of the first sensing period and is reset at the end of the last sensing period, and the fingerprint identification device is exposed to light from the beginning of the first sensing period to the end of the last sensing period. Therefore, in a limited time, a plurality of sample images with good quality are provided to the end process. The image with good quality is an effective image without effect of environment light. That is to say, the effective image clearly shows the ridges and valleys of the fingerprint of the finger. Consequently, it guarantees to obtain an optimized image of the finger in a limited and short time.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of a fingerprint identification apparatus according to one embodiment of the disclosure.

FIG. 1B is a schematic view of a fingerprint identification apparatus according to another embodiment of the disclosure.

FIG. 2 is a schematic view showing a time-sharing method of the fingerprint identification device and the touch and display integration circuit in another embodiment of the disclosure.

FIG. 3 is a schematic view showing the first sensing period in FIG. 2.

FIG. 4 is a graphs illustrating a relationship between brightness and time in the first sensing period in FIG. 3.

FIG. 5 is a schematic view showing a circuit in the fingerprint identification device according to the embodiment in FIG. 2.

FIG. 6 is a schematic view showing both the first sensing period and the last sensing period in FIG. 2.

FIG. 7 is a schematic view showing an end process according the embodiment in FIG. 2.

FIG. 8 is a schematic view showing a time-sharing method of the fingerprint identification device and the touch and display integration circuit in another embodiment of the disclosure.

FIG. 9, FIG. 10, FIG. 11A, and FIG. 11B are flow charts illustrating a fingerprint identification method of a fingerprint identification apparatus of the disclosure.

### DESCRIPTION OF THE EMBODIMENTS

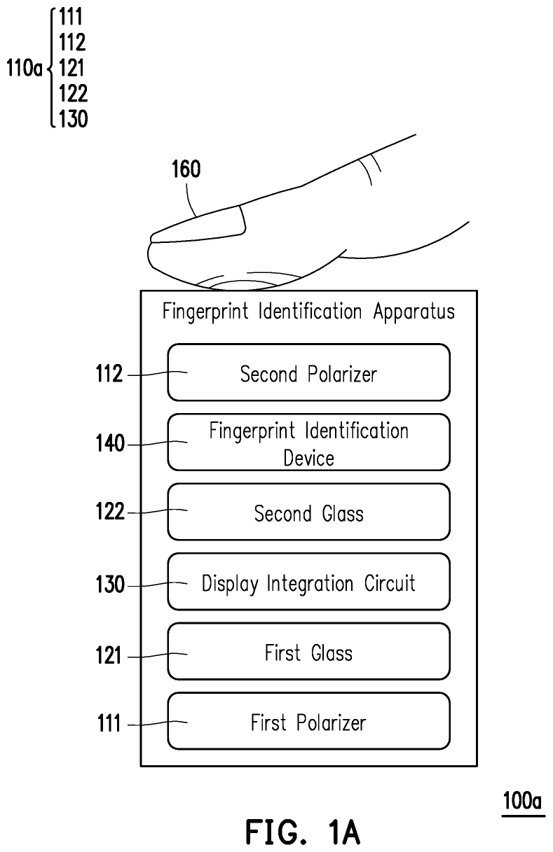

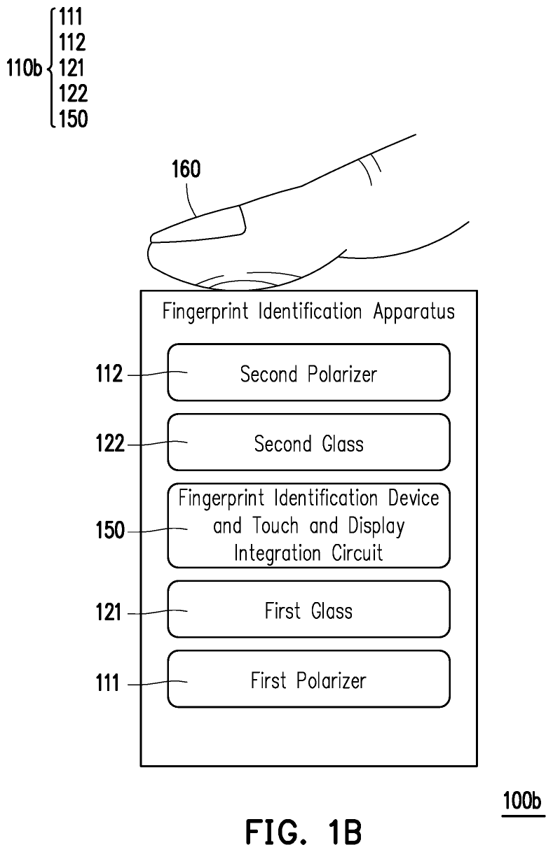

FIG. 1A is a schematic view of a fingerprint identification apparatus according to one embodiment of the disclosure. As shown in FIG. 1A, a fingerprint identification apparatus 100a includes a display panel 110a, which may be a display of a smart phone. The display panel 110a includes a first polarizer 111, a second polarizer 112, a first glass 121, a second glass 122, and a touch and display integration circuit 130. The first glass 121 and the second glass 122 are disposed between the first polarizer 111 and the second polarizer 112. The touch and display integration circuit 130 is disposed between the first glass 121 and the second glass 122. In addition, the fingerprint identification apparatus 100a further includes a fingerprint identification device 140 disposed in the display panel 110a and between the second glass 122 and the second polarizer 112. That is to say, the fingerprint identification device 140 is disposed in the display panel 110a and above the touch and display integration circuit 130.

Further, an object 160, such as a finger of the user, is in contact with a predetermined area of the display panel 110a for fingerprint identification purpose. The touch and display integration circuit 130 is configured to perform touch and display function. The fingerprint identification device 140 is configured to sense the fingerprint of the finger 160. Herein, the fingerprint identification device 140 may be realized by an optical image sensor having a photodiode. The touch and display integration circuit 130 may be realized by combining two chips into one or by integrating touch controller and display driver. The disclosure is not limited thereto.

FIG. 1B is a schematic view of a fingerprint identification apparatus according to another embodiment of the disclosure. To be more specific, a fingerprint identification apparatus 100b having a display panel 110b is shown in FIG. 1B. The fingerprint identification apparatus 100b in FIG. 1B is similar to the fingerprint identification apparatus 100a is shown in FIG. 1A, the difference is that, in fingerprint identification apparatus 100b, an element 150 is formed by integrating the fingerprint identification device 140 with the touch and display integration circuit 130 and is disposed between the first glass 121 and the second glass 122 in the display panel 110b.

Normally, the finger 160 touches the display panel 110a or 110b during a total contact time T so that the fingerprint of the finger 160 is obtained. The total contact time T may be equal to 100 milliseconds or 150 milliseconds, the disclosure is not limited thereto. In the present application, the fingerprint identification device 140 and the touch and display integration circuit 130, either integrated or separated, used time-sharing method in the total contact time T in order to obtain the fingerprint of the finger 160. The details will be described hereinafter.

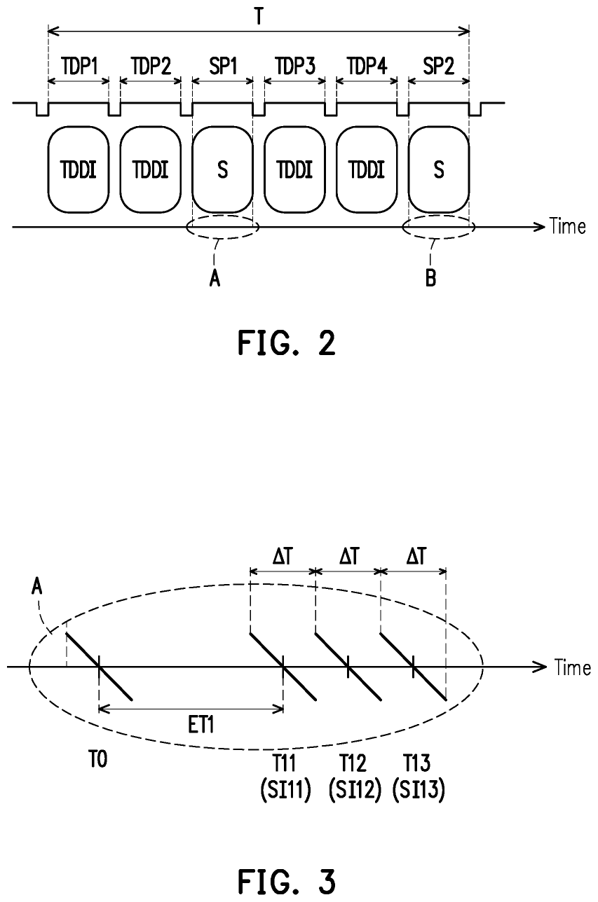

FIG. 2 is a schematic view showing a time-sharing method of the fingerprint identification device and the touch and display integration circuit in another embodiment of the disclosure. As shown in FIG. 2, the touch and display integration circuit 130 performs a touch and display function TDDI in each of a plurality of touch and display periods TDP1 to TDP4 during the total contact time T. It should be noted here, the object 160 touches the predetermined area of the display panel 110a or 110b during the total contact time T. In addition, the fingerprint identification device 140 performs a sensing function S in each of a plurality of sensing periods SP1 to SP2 during the total contact time T. In each of the sensing function S, the fingerprint identification device 140 obtains a plurality of sample images of the fingerprint of the finger 160. In addition, two adjacent sensing periods SP1 and SP2 have at least one of the touch and display periods TDP1 to TDP4 therebetween. To be more specific, in the present embodiment and during the total contact time T, the touch and display periods TDP1 and TDP2 are arranged before the sensing period SP1, the touch and display periods TDP3 and TDP4 are arranged after the sensing period SP1 and before the sensing period SP2. Therefore, the touch and display periods TDP3 and TDP4 are arranged between the sensing period SP1 and the sensing period SP2, which are two adjacent sensing periods.

In the present embodiment, the arrangement is that there is one sensing period arranged after two touch and display periods, but the disclosure is not limited thereto. Further, there are two sensing periods in the present embodiment, but the disclosure is not limited thereto. In the present embodiment, the sensing period SP1 is called as the first sensing period SP1, and the sensing period SP2 is called as the last sensing period SP2. In other embodiments, there may be a plurality of intervening sensing periods between the first sensing period SP1 and the last sensing period SP2. Next, along time axis, the first sensing period SP1 and the last sensing period SP2 are described as follows.

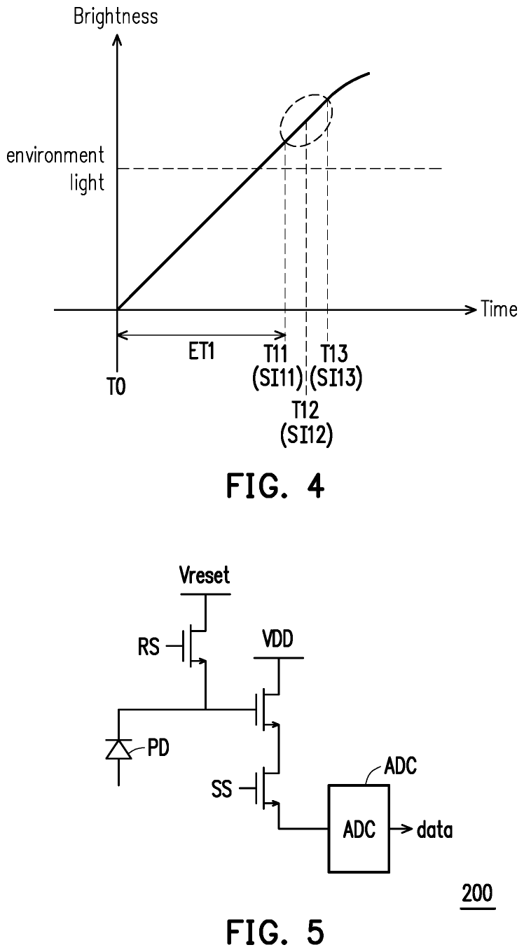

FIG. 3 is a schematic view showing the first sensing period in FIG. 2. To be more specific, as shown in FIG. 3, the first sensing period SP1 begins at the timepoint T0. At the timepoint T0, the fingerprint identification device 140 is reset. For example, the fingerprint identification device 140 has a photodiode, and the photodiode is reset in order to reset the fingerprint identification device 140. After that the fingerprint identification device 140 is exposed in an exposure time ET1 until the time T11. Next, the fingerprint identification device 140 captures/obtains the first sample image SI11 of the fingerprint of the finger 160 touching the display panel at the time T11. After that the fingerprint identification device 140 captures the second sample image SI12 of the fingerprint of the finger 160 touching the display panel at the time T12, and the capturing process occurs during the time ΔT. Next, the fingerprint identification device 140 captures the third sample image SI13 of the fingerprint of the finger 160 touching the display panel at the time T13, and the capturing process occurs during the time ΔT. In the present embodiment, the first sensing period SP1 ends after the third sample image SI13 is taken. However, in other embodiments, there may be more than three sample images obtained in one sensing period, the disclosure is not limited thereto.

It should be noted here, the fingerprint identification device 140 is reset at the timepoint T0, but the fingerprint identification device 140 is not reset again after obtaining the first sample image SI11, after obtaining the second sample image SI12, after obtaining the third sample image SI13, or after the first sensing period SP1 ends. That is to say, after reset, the fingerprint identification device 140 is exposed from the timepoint T0 (such as the photodiode of the fingerprint identification device 140 is exposed in order to obtain sample images of the fingerprint of the finger). Therefore, the first sample image SI11, and the second sample image SI12, and the third sample image SI13 have different brightness values. In other words, the brightness of the third sample image SI13 is greater than the brightness of the second sample image SI12, and the brightness of the second sample image SI12 is greater than the brightness of the first sample image SI11.

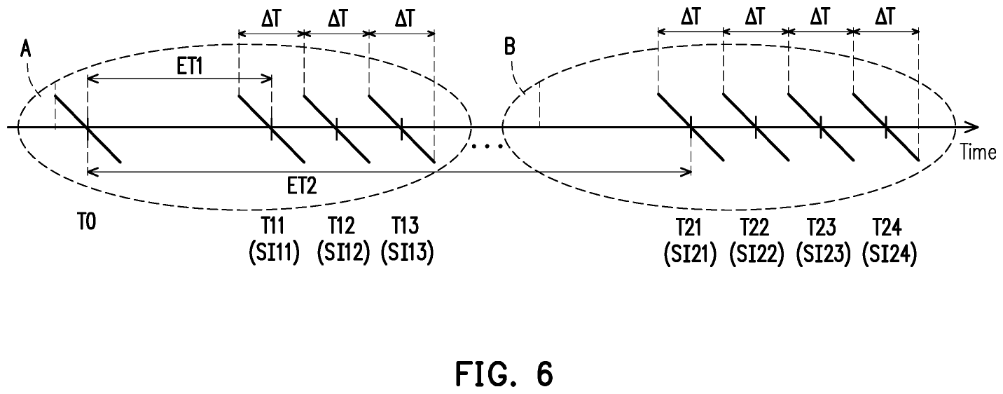

FIG. 4 is a graph illustrating a relationship between brightness and time in the first sensing period in FIG. 3. As shown in FIG. 4, after the fingerprint identification device 140 is reset and exposed at the timepoint T0, the amount of light reaching the image sensor or the photodiode of the fingerprint identification device 140 increases over time. After the exposure time ET1, the first sample image SI11, the second sample image SI12, and the third sample image SI13 are obtained in sequence at the time T11, the time T12, and the time T13, respectively. Because the amount of light reaching the fingerprint identification device 140 at the time T13 is greater than the amount of light reaching the fingerprint identification device 140 at the time T12, the brightness of the third sample image SI13 is greater than the brightness of the second sample image SI12. Similarly, because the amount of light reaching the fingerprint identification device 140 at the time T12 is greater than the amount of light reaching the fingerprint identification device 140 at the time T11, the brightness of the second sample image SI12 is greater than the brightness of the first sample image SI11.

However, after the first sample image SI11 is obtained, the first sample image SI11 is used to calculate the effect of the environment light. The environment light may be the light from the outside of the display panel and the backlight of the display panel, but the disclosure is not limited thereto. Further, the effect of the environment light is eliminated when obtaining the second sample image SI12 and the third sample image SI13.

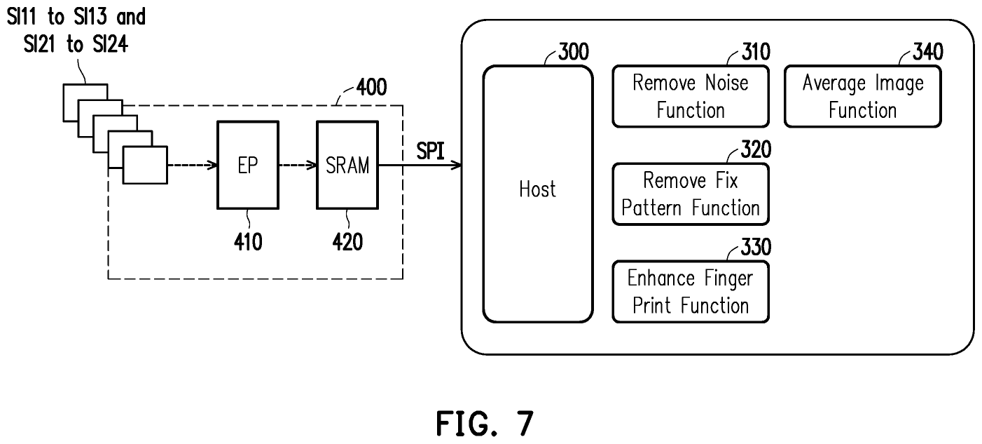

FIG. 5 is a schematic view showing a circuit in the fingerprint identification device according to the embodiment in FIG. 2. As shown in FIG. 5, a circuit 200 in the fingerprint identification device 140 includes a photodiode PD, a reset switch RS, and a select switch SS, and an analog-to-digital converter ADC. The reset switch RS is coupled to a reset voltage Vreset, the photodiode PD is coupled to the reset switch RS, the photodiode PD and the reset switch RS are coupled to a power supply VDD and are also coupled to the select switch SS. In addition, the select switch SS is coupled to the analog-to-digital converter ADC. The data obtained by the photodiode PD is processed by eliminating the effect of the environment light so as to obtain an actual data of the sample image. Only the actual data of the sample image is provided to the analog-to-digital converter ADC so that the difference between the ridges and valleys of the fingerprint is better shown in the sample image.

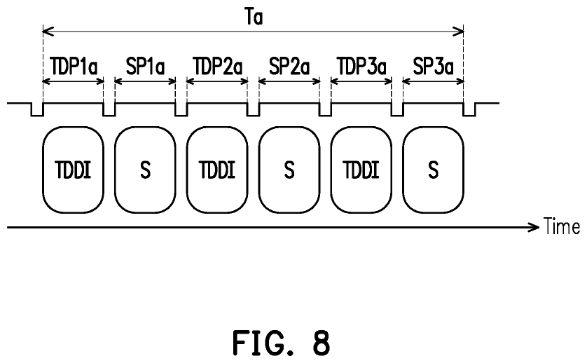

FIG. 6 is a schematic view showing both the first sensing period and the last sensing period in FIG. 2. Although both the first sensing period SP1 and the last sensing period SP2 are shown in FIG. 6, the detail description of the first sensing period SP1 is mentioned above, and the last sensing period SP2 is described hereinafter. To be more specific, the fingerprint identification device 140 is reset at the timepoint T0 and then is exposed in an exposure time ET2 until the time T21. Next, the fingerprint identification device 140 captures/obtains the first sample image SI21 of the fingerprint of the finger 160 touching the display panel at the time T21. The first sample image SI21 is used to recalculate the effect of the environment light. After that the second sample image SI22, the third sample image SI23, and the fourth sample image SI24 are sequentially obtained at the time T22, the time T23, and the time T24, respectively. The effect of the environment light is eliminated when obtaining the second sample images SI22 to SI24. The capturing process of each of the sample images SI21 to SI24 occurs during the time ΔT. In the present embodiment, the last sensing period SP2 ends after the fourth sample image SI24 is taken. However, in other embodiments, there may be more than four sample images obtained in one sensing period, the disclosure is not limited thereto.

It should be noted here, the end of the last sensing period SP2 is also the end of the total contact time T. That is to say, the end of the last sensing period SP2 is the end of the process to obtain the fingerprint of the finger 160. However, the disclosure is not limited thereto. The end of the last sensing period SP2 may be sooner than the end of the total contact time T in other embodiment.

After the last sensing period SP2 ends, the fingerprint identification device 140 is reset again, thus the fingerprint identification device 140 is not exposed to light anymore. That is to say, the fingerprint identification device 140 is reset at the beginning of the first sensing period SP1 and is reset again at the end of the last sensing period SP2. In addition, the fingerprint identification device 140 is not reset between the beginning of the first sensing period SP1 and the end of the last sensing period SP2. In other words, the photodiode or the image sensor of the fingerprint identification device 140 is continuously exposed to light from the beginning of the first sensing period SP1 to the end of the last sensing period SP2.

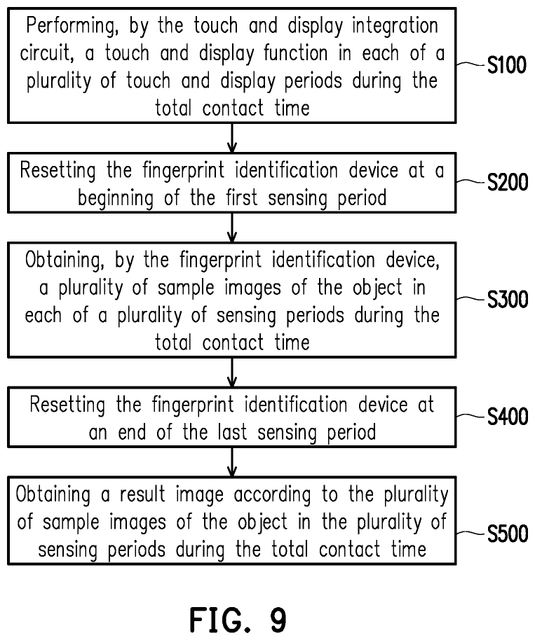

FIG. 7 is a schematic view showing an end process according the embodiment in FIG. 2. To be more specific, in the end process, there is a host 300 and an integrated circuit 400 having an encryption process 410 and a static random-access memory 420. After eliminating the effect of environment light, the data of the sample images SI11 to SI13 and the sample images SI21 to SI24 is obtained and provided to the integrated circuit 400. In the integrated circuit 400, the data of the sample images SI11 to SI13 and the sample images SI21 to SI24 is encrypted by the encryption process (EP) 410 and then is stored in the static random-access memory 420. Next, the encrypted data is transmitted via a serial peripheral interface (SPI) to the host 300. In the host 300, a result image is determined according to the contrast between ridges and valleys of the fingerprint of the finger 160 in the sample images SI11 to SI13 and the sample images SI21 to SI24 obtained in the sensing periods SP1 and SP2. For example, the result image has the highest brightness contrast between ridges and valleys of the fingerprint and is one of the sample images SI11 to SI13 and the sample images SI21 to SI24. The result image is picked from the sample images SI11 to SI13 and the sample images SI21 to SI24 by artificial intelligence (AI) or other method. In other ways, the host 300 may perform a remove noise function 310, a remove fix pattern function 320, or an enhance finger print function 330 in order to obtain the result image. Further, the host 300 may perform an average image function 340 to obtain the result image. To be more specific, the result image is obtained by averaging the sample images SI11 to SI13 and the sample images SI21 to SI24.

In the present embodiment, a plurality of sample images SI11 to SI13 of the finger 160 are obtained in the sensing period SP1, and a plurality of sample images SI21 to SI24 of the finger 160 are obtained in the sensing period SP2. In addition, the first sample image SI11 in the sensing period SP1 is used to calculate in order to obtain the effect of environment light, and the other sample images SI12 and SI13 in the sensing period SP1 are obtained by eliminating the effect of environment light. Similarly, the first sample image SI21 in the sensing period SP2 is used to recalculate in order to obtain the effect of environment light, and the other sample images SI22 to SI24 in the sensing period SP2 are obtained by eliminating the effect of environment light. Further, the sensing periods have the first sensing period SP1 and the last sensing period SP2. The fingerprint identification device 140 is reset at the beginning of the first sensing period SP1 and is reset at the end of the last sensing period SP2, and the fingerprint identification device 140 is exposed to light from the beginning of the first sensing period SP1 to the end of the last sensing period SP2. Therefore, in a limited time, a plurality of sample images SI11 to SI13 and a plurality of sample images SI21 to SI24 with good quality (or effective images without effect of environment light) are provided to the end process. Consequently, it guarantees to obtain an optimized image of the finger in a limited and short time.

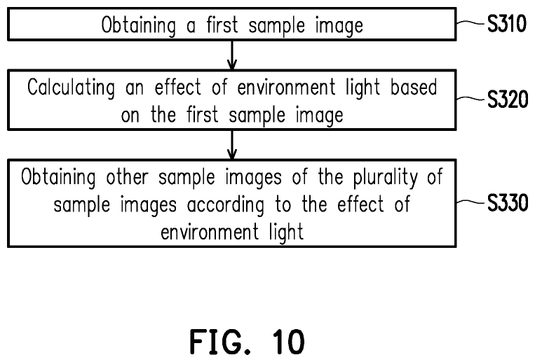

FIG. 8 is a schematic view showing a time-sharing method of the fingerprint identification device and the touch and display integration circuit in another embodiment of the disclosure. The present embodiment is similar to the embodiment in FIG. 2, only differences are described hereinafter. As shown in FIG. 7, the touch and display integration circuit 130 performs a touch and display function TDDI in each of a plurality of touch and display periods TDP1a to TDP3a during the total contact time Ta. In addition, the fingerprint identification device 140 performs a sensing function S in each of a plurality of sensing periods SP1a to SP3a during the total contact time Ta. In each of the sensing function S, the fingerprint identification device 140 obtains a plurality of sample images of the fingerprint of the finger 160. However, in the present embodiment, the sensing period SP1a is the first sensing period, the sensing period SP3a is the last sensing period, and the sensing period SP2a is the intervening sensing period. In the present embodiment, there is one intervening sensing period between the first sensing period and the last sensing period, but the disclosure is not limited thereto. In other embodiments, there may be more than one intervening sensing period between the first sensing period and the last sensing period.

Further, in the present embodiment, the sensing periods SP1a to SP3a and the touch and display periods TDP1a to TDP3a are alternately arranged during the total contact time Ta. In other words, the sensing periods SP1a to SP3a and the touch and display periods TDP1a to TDP3a are arranged one after another. However, the disclosure is not limited thereto.

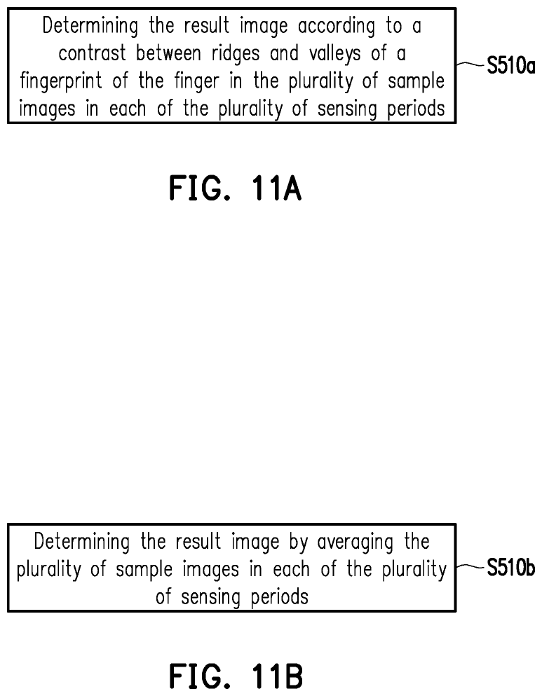

FIG. 9, FIG. 10, FIG. 11A, and FIG. 11B are flow charts illustrating a fingerprint identification method of a fingerprint identification apparatus of the disclosure. The fingerprint identification method in FIG. 9, FIG. 10, FIG. 11A, and FIG. 11B is applied to the embodiment in FIG. 2, FIG. 3, and FIG. 6 as an example. As shown in FIG. 9, in step S100, the touch and display integration circuit 130 performs a touch and display function TDDI in each of the touch and display periods TDP1 to TDP4 during the total contact time T. Next, in the step S200, the fingerprint identification device 140 is reset at the beginning of the first sensing period SP1. After that, during the total contact time T, the fingerprint identification device 140 obtains the sample images of the object 160 in each of the sensing periods SP1 and SP2 (step S300). To be more specific, the fingerprint identification device 140 obtains the sample images SI11 to SI13 of the object 160 in the first sensing period SP1, and obtains the sample images SI21 to SI23 of the object 160 in the last sensing period SP2.

In step S300, there may be three sub-steps S310, S320, and S330 in obtaining the sample images of the object in each of the sensing periods. The sensing period SP1 is used as example hereinafter. In sub-step S310, the first sample image SI11 is obtained. Next, in sub-step S320, an effect of environment light is calculated based on the first sample image SI11. Further, in sub-step S330, the other sample images SI12 and SI13 of the sample images are obtained according to the effect of environment light.

After the last sensing period SP2 ends, the fingerprint identification device 140 is reset. In other words, the fingerprint identification device 140 is reset at the end of the last sensing period SP2 (step S400).

Next, in step S500, a result image is obtained according to the sample images SI11 to SI13 and the sample images SI21 to SI24 of the object 160 in the sensing periods SP1 and SP2 during the total contact time T. There may be two alternative sub-steps S510a or S510b in the step S500. In the sub-step S510a, the result image is determined according to the contrast between ridges and valleys of the fingerprint of the finger 160 in the sample images SI11 to SI13 and SI21 to SI24 in the sensing periods SP1 and SP2. As an alternative way, in the sub-step S510b, the result image is determined by averaging the sample images SI11 to SI13 and SI21 to SI24 in the sensing periods SP1 and SP2. In other ways, the result image may have the highest brightness contrast between ridges and valleys of the fingerprint is one of the sample images SI11 to SI13 and the sample images SI21 to SI24. The result image is picked from the sample images SI11 to SI13 and the sample images SI21 to SI24 by artificial intelligence (AI) or other method. The disclosure is not limited thereto.

In summary, two adjacent sensing periods have at least one of the touch and display periods therebetween, and a plurality of sample images of the finger are obtained in each of the sensing periods. In addition, the first sample image in each of the sensing periods is used to calculate in order to obtain the effect of environment light, and the other sample images in the same sensing period are obtain by eliminating the effect of environment light. Further, the sensing periods have the first sensing period and the last sensing period. The fingerprint identification device is reset at the beginning of the first sensing period and is reset at the end of the last sensing period, and the fingerprint identification device is exposed to light from the beginning of the first sensing period to the end of the last sensing period. Therefore, in a limited time, a plurality of sample images with good quality are provided to the end process. The image with good quality is an effective image without effect of environment light. That is to say, the effective image clearly shows the ridges and valleys of the fingerprint of the finger. Consequently, it guarantees to obtain an optimized image of the finger in a limited and short time.

Moreover, since the optimized image of the finger is obtained without using the AE process, so as to avoid the possibility that the exposure time is not converged in a limited time.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A fingerprint identification apparatus, comprising:
a touch and display integration circuit configured to perform a touch and display function in each of a plurality of touch and display periods during a total contact time, wherein an object touches a predetermined area of a display panel during the total contact time; and
a fingerprint identification device, configured to obtain a plurality of sample images of the object in each of a plurality of sensing periods during the total contact time, wherein two adjacent sensing periods have at least one of the touch and display periods therebetween.

2. The fingerprint identification apparatus as recited in claim 1, wherein the plurality of sensing periods comprise a first sensing period and a last sensing period, and the fingerprint identification device is reset at a beginning of the first sensing period and at an end of the last sensing period.

3. The fingerprint identification apparatus as recited in claim 2, wherein the fingerprint identification device is not reset between the beginning of the first sensing period and the end of the last sensing period.

4. The fingerprint identification apparatus as recited in claim 2, wherein the plurality of sensing periods further comprise at least one intervening sensing period arranged between the first sensing period and the last sensing period.

5. The fingerprint identification apparatus as recited in claim 2, wherein the fingerprint identification device comprises an optical image sensor having a photodiode, the photodiode is reset at the beginning of the first sensing period and at the end of the last sensing period, and the photodiode is continuously exposed to light from the beginning of the first sensing period to the end of the last sensing period.

6. The fingerprint identification apparatus as recited in claim 1, wherein the plurality of sensing periods and the plurality of touch and display periods are alternately arranged during the total contact time.

7. The fingerprint identification apparatus as recited in claim 1, wherein the fingerprint identification device is disposed in the display panel and above the touch and display integration circuit.

8. The fingerprint identification apparatus as recited in claim 1, wherein the fingerprint identification device is integrated with the touch and display integration circuit in the display panel.

9. A fingerprint identification method of a fingerprint identification apparatus having a fingerprint identification device and a touch and display integration circuit, an object being in contact with a predetermined area of a display panel during a total contact time, comprising:
performing, by the touch and display integration circuit, a touch and display function in each of a plurality of touch and display periods during the total contact time;
obtaining, by the fingerprint identification device, a plurality of sample images of the object in each of a plurality of sensing periods during the total contact time; and
obtaining a result image according to the plurality of sample images of the object in each of the plurality of sensing periods during the total contact time, wherein two adjacent sensing periods have at least one of the touch and display periods therebetween.

10. The fingerprint identification method of the fingerprint identification apparatus as recited in claim 9, wherein the plurality of sensing periods comprise a first sensing period and a last sensing period, the fingerprint identification method further comprises:
resetting the fingerprint identification device at a beginning of the first sensing period; and
resetting the fingerprint identification device at an end of the last sensing period.

11. The fingerprint identification method of the fingerprint identification apparatus as recited in claim 10, wherein the fingerprint identification device is not reset between the beginning of the first sensing period and the end of the last sensing period.

12. The fingerprint identification method of the fingerprint identification apparatus as recited in claim 10, wherein the plurality of sensing periods comprise at least one intervening sensing period between the first sensing period and the last sensing period.

13. The fingerprint identification method of the fingerprint identification apparatus as recited in claim 10, wherein the fingerprint identification device comprises an optical image sensor having a photodiode, the photodiode is reset at the beginning of the first sensing period and at the end of the last sensing period, and the photodiode is continuously exposed to light from the beginning of the first sensing period to the end of the last sensing period.

14. The fingerprint identification method of the fingerprint identification apparatus as recited in claim 9, wherein step of obtaining, by the fingerprint identification device, the plurality of sample images of the object in each of the plurality of sensing periods during the total contact time comprises:
obtaining a first sample image;
calculating an effect of environment light based on the first sample image; and
obtaining other sample images of the plurality of sample images according to the effect of environment light.

15. The fingerprint identification method of the fingerprint identification apparatus as recited in claim 9, wherein the object is a finger, step of obtaining the result image according to the plurality of sample images of the object in each of the plurality of sensing periods during the total contact time comprises:
determining the result image according to a contrast between ridges and valleys of a fingerprint of the finger in the plurality of sample images in each of the plurality of sensing periods.

16. The fingerprint identification method of the fingerprint identification apparatus as recited in claim 9, wherein step of obtaining the result image according to the plurality of sample images of the object in each of the plurality of sensing periods during the total contact time comprises:
determining the result image by averaging the plurality of sample images in each of the plurality of sensing periods.

17. The fingerprint identification method of the fingerprint identification apparatus as recited in claim 9, wherein the plurality of sensing periods and the plurality of touch and display periods are alternately arranged during the total contact time.
